(19) United States
(12) Patent Application Publication
(10) Pub. No.: US 2019/0194407 A1
(43) Pub. Date: Jun. 27, 2019

(54) SEMI-CRYSTALLINE THERMOPLASTIC POLYESTER FOR PRODUCING BIORIENTED FILMS

(71) Applicant: ROQUETTE FRERES, Lestrem (FR)

(72) Inventors: Hélène AMEDRO, BETHUNE (FR); René SAINT-LOUP, LOMME (FR)

(21) Appl. No.: 16/322,360

(22) PCT Filed: Aug. 3, 2017
(86) PCT No.: PCT/FR2017/052177

§ 371 Date: Jan. 31, 2019

(30) Foreign Application Priority Data
Aug. 3, 2016 (FR) 16 57545

(51) Int. Cl. C08J 5/18; C08G 63/672; B29C 55/12; B29C 55/00

(52) U.S. Cl. CPC C08J 5/18; C08G 63/672; B29K 2067/00; B29C 55/005; C08J 2367/02; B29C 55/12

(57) ABSTRACT

Use of a semi-crystalline thermoplastic polyester for producing bioriented films, said polyester having at least one 1,4:3,6-dianhydrohexitol unit (A), at least one alicyclic diol unit (B) other than the 1,4:3,6-dianhydrohexitol units (A), and at least one terephthalic acid unit (C), wherein the molar ratio (A)/[(A)+(B)] is at least 0.05 and at most 0.30, said polyester being free of non-cyclic aliphatic diol units or comprising a molar amount of non-cyclic aliphatic diol units, relative to the totality of monomeric units in the polyester, of less than 5%, and with a reduced viscosity in solution (25° C.; phenol (50 wt. %): ortho-dichlorobenzene (50 wt. %); 5 g/L of polyester) greater than 50 mL/g.

### FIELD OF THE INVENTION

The present invention relates to the use of a semicrystalline thermoplastic polyester comprising at least one 1,4:3,6-dianhydrohexitol unit which has excellent properties for producing biaxially oriented films.

### TECHNICAL BACKGROUND OF THE INVENTION

Plastics have become inescapable in the mass production of objects. Indeed, their thermoplastic character enables these materials to be transformed at a high rate into all kinds of objects.

Certain thermoplastic aromatic polyesters have thermal properties which allow them to be used directly for the production of materials. They comprise aliphatic diol and aromatic diacid units. Among these aromatic polyesters, mention may be made of polyethylene terephthalate (PET), which is a polyester comprising ethylene glycol and terephthalic acid units, used for example in the production of biaxially oriented films.

However, for certain applications or under certain usage conditions, it is necessary to improve certain properties, especially impact strength or else heat resistance. This is why glycol-modified PETs (PETgs) have been developed. These are generally polyesters comprising, in addition to the ethylene glycol and terephthalic acid units, cyclohexanedimethanol (CHDM) units. The introduction of this diol into the PET enables it to adapt the properties to the intended application, for example to improve its impact strength or its optical properties.

Other modified PETs have also been developed by introducing, into the polyester, 1,4:3,6-dianhydrohexitol units, especially isosorbide (PEIT). These modified polyesters have higher glass transition temperatures than the unmodified PETs or the PETgs comprising CHDM. In addition, 1,4:3,6-dianhydrohexitols have the advantage of being able to be obtained from renewable resources such as starch.

One problem with these PEITs is that they may have insufficient impact strength properties. In addition, the glass transition temperature may be insufficient for the production of certain plastic objects.

In order to improve the impact strength properties of the polyesters, it is known from the prior art to use polyesters of which the crystallinity has been reduced. As regards isosorbide-based polyesters, mention may be made of application US2012/0177854, which describes polyesters comprising terephthalic acid units and diol units comprising from 1 to 60 mol % of isosorbide and from 5 to 99% of 1,4-cyclohexanedimethanol which have improved impact strength properties. As indicated in the introductory section of this application, the aim is to obtain polymers of which the crystallinity is eliminated by the addition of comonomers, and hence in this case by the addition of 1,4-cyclohexanedimethanol. In the examples section, the production of various poly(ethylene-co-1,4-cyclohexanedimethylene-co-isosorbide)terephthalates (PECITs), and also an example of poly(1,4-cyclohexanedimethylene-co-isosorbide)terephthalate (PCIT), are described.

It may also be noted that while polymers of PECIT type have been the subject of commercial developments, this is not the case for PCITs. Indeed, their production was hitherto considered to be complex, since isosorbide has low reactivity as a secondary diol. Yoon et al. (Synthesis and Characteristics of a Biobased High-Tg Terpolyester of Isosorbide, Ethylene Glycol, and 1,4-Cyclohexane Dimethanol: Effect of Ethylene Glycol as a Chain Linker on Polymerization, Macromolecules, 2013, 46, 7219-7231) thus showed that the synthesis of PCIT is much more difficult to achieve than that of PECIT. This paper describes the study of the influence of the ethylene glycol content on the PECIT production kinetics.

In Yoon et al., an amorphous PCIT (which comprises approximately 29% of isosorbide and 71% of CHDM, relative to the sum of the diols) is produced to compare its synthesis and its properties with those of PECIT-type polymers. The use of high temperatures during the synthesis induces thermal degradation of the polymer formed if reference is made to the first paragraph of the Synthesis section on page 7222, this degradation especially being linked to the presence of aliphatic cyclic diols such as isosorbide. Therefore, Yoon et al. used a process in which the polycondensation temperature is limited to 270° C. Yoon et al. observed that, even increasing the polymerization time, the process also does not make it possible to obtain a polyester having a sufficient viscosity. Thus, without addition of ethylene glycol, the viscosity of the polyester remains limited, this being despite the use of prolonged synthesis times.

Thus, despite the modifications made to the PETs, there is still a constant need for novel polyesters having improved properties.

In the plastics field, in particular for the production of biaxially oriented films, it is necessary to have available semicrystalline thermoplastic polyesters with improved properties which make it possible to obtain biaxially oriented films that have a better heat resistance and also improved mechanical properties such as yield strength and tear strength.

Objects produced from polymers having terephthalic acid functions, ethylene glycol units and isosorbide units and optionally another diol (for example 1,4-cyclohexanedimethanol) are known from document U.S. Pat. No. 6,126,992. All the polymers obtained thus have ethylene glycol units, since it is widely accepted that they are necessary for the incorporation of the isosorbide and for obtaining a high glass transition temperature. Furthermore, the preparation examples implemented do not make it possible to obtain from the polymers a unit composition able to be entirely satisfactory in the production of biaxially oriented films. Indeed, example 1 describes in particular the preparation of a polymer comprising 33.5% of ethylene glycol unit and 12.9% of isosorbide unit, i.e. an isosorbide unit/ethylene glycol unit ratio of 0.39, which is not convincing for biaxially oriented film production.

Document U.S. Pat. No. 5,958,581 describes biaxially oriented polyester films produced from a polymer having isosorbide units, terephthalic acid units and ethylene glycol units. The biaxially oriented films thus produced are suitable for use in particular as food packaging or as insulating material.

Thus, there is currently still a need to have semicrystalline thermoplastic polyesters containing 1,4:3,6-dianhydrohexitol for producing biaxially oriented films, said polyesters making it possible to obtain biaxially oriented films which have improved mechanical properties.

It is thus to the applicant's credit to have found that this objective could, against all expectations, be achieved with a semicrystalline thermoplastic polyester based on isosorbide and not having ethylene glycol, while it was hitherto known that the latter was essential for the incorporation of said isosorbide. Indeed, by virtue of a particular viscosity and a particular ratio of units, the semicrystalline thermoplastic polyester used according to the present invention has improved properties for a use according to the invention in the production of biaxially oriented films.

### SUMMARY OF THE INVENTION

Thus, a subject of the invention is the use of a semicrystalline thermoplastic polyester for producing biaxially oriented films, said polyester comprising:
at least one 1,4:3,6-dianhydrohexitol unit (A);
at least one alicyclic diol unit (B) other than the 1,4:3,6-dianhydrohexitol units (A);
at least one terephthalic acid unit (C);
wherein the (A)/[(A)+(B)] ratio is at least 0.05 and at most 0.30;
   said polyester not containing any aliphatic non-cyclic diol units or comprising a molar amount of aliphatic non-cyclic dial units, relative to all the monomer units of the polyester, of less than 5%, and the reduced viscosity in solution (25° C.; phenol (50%m): ortho-dichlorobenzene (50%m); 5 g/l of polyester) of said polyester being greater than 50 ml/g.

A second subject of the invention relates to a process for producing biaxially oriented films based on the semicrystalline thermoplastic polyester described above.

Finally, a third subject of the invention relates to a biaxially oriented film comprising the semicrystalline thermoplastic polyester previously described.

These semicrystalline thermoplastic polyesters offer excellent properties and make it possible in particular to produce biaxially oriented films which have better heat resistance and improved mechanical properties.

### DETAILED DESCRIPTION OF THE INVENTION

A first subject of the invention relates to the use of a semicrystalline thermoplastic polyester for producing biaxially oriented films, said polyester comprising:
at least one 1,4:3,6-dianhydrohexitol unit (A);
at least one alicyclic diol unit (B) other than the 1,4:3,6-dianhydrohexitol units (A);
at least one terephthalic acid unit (C);
   wherein the (A)/[(A)+(B)] molar ratio is at least 0.05 and at most 0.30 and the reduced viscosity in solution is greater than 50 ml/g.

“(A)/[(A)+(B)] molar ratio” is intended to mean the molar ratio of 1,4:3,6-dianhydrohexitol units (A)/sum of 1,4:3,6-dianhydrohexitol units (A) and alicyclic diol is units (B) other than the 1,4:3,6-dianhydrohexitol units (A).

The semicrystalline thermoplastic polyester is free of non-cyclic aliphatic diol units, or comprises a small amount thereof.

“Small molar amount of aliphatic non-cyclic diol units” is intended to mean, especially, a molar amount of aliphatic non-cyclic diol units of less than 5%. According to the invention, this molar amount represents the ratio of the sum of the aliphatic non-cyclic diol units, these units possibly being identical or different, relative to all the monomer units of the polyester.

An aliphatic non-cyclic diol may be a linear or branched aliphatic non-cyclic diol. It may also be a saturated or unsaturated aliphatic non-cyclic diol. Aside from ethylene glycol, the saturated linear aliphatic non-cyclic diol may for example be 1,3-propanediol, 1,4-butanediol, 1,5-pentanediol, 1,6-hexanediol, 1,8-octanediol and/or 1,10-decanediol. As examples of saturated branched aliphatic non-cyclic diol, mention may be made of 2-methyl-1,3-propanediol, 2,2,4-trimethyl-1,3-pentanediol, 2-ethyl-2-butyl-1,3-propanediol, propylene glycol and/or neopentyl glycol. As an example of an unsaturated aliphatic diol, mention may be made, for example, of cis-2-butene-1,4-diol.

This molar amount of aliphatic non-cyclic diol unit is advantageously less than 1%. Preferably, the polyester does not contain any aliphatic non-cyclic diol units and more preferentially it does not contain any ethylene glycol.

Despite the low amount of aliphatic non-cyclic diol, and hence of ethylene glycol, used for the synthesis, a semicrystalline thermoplastic polyester is surprisingly obtained which has a high reduced viscosity in solution and in which the isosorbide is particularly well incorporated. Without being bound by any one theory, this would be explained by the fact that the reaction kinetics of ethylene glycol are much faster than those of 1,4:3,6-dianhydrohexitol, which greatly limits the integration of the latter into the polyester. The polyesters resulting therefrom thus have a low degree of integration of 1,4:3,6-dianhydrohexitol and consequently a relatively low glass transition temperature.

The monomer (A) is a 1,4:3,6-dianhydrohexitol and may be isosorbide, isomannide, isoidide, or a mixture thereof. Preferably, the 1,4:3,6-dianhydrohexitol (A) is isosorbide. Isosorbide, isomannide and isoidide may be obtained, respectively, by dehydration of sorbitol, of mannitol and of iditol. As regards isosorbide, it is sold by the applicant under the brand name Polysorb® P.

The alicyclic diol (B) is also referred to as aliphatic and cyclic diol. It is a diol which may especially be chosen from 1,4-cyclohexanedimethanol, 1,2-cyclohexanedimethanol, 1,3-cyclohexanedimethanol or a mixture of these diols. The alicyclic diol (B) is very preferentially 1,4-cyclohexanedimethanol. The alicyclic diol (B) may be in the cis configuration, in the trans configuration, or may be a mixture of diols in the cis and trans configurations.

The molar ratio of 1,4:3,6-dianhydrohexitol units (A)/sum of 1,4:3,6-dianhydrohexitol units (A) and alicyclic diol units (B) other than the 1,4:3,6-dianhydrohexitol units (A), i.e. (A)/[(A)+(B)], is at least 0.05 and at most 0.30. Advantageously, this ratio is at least 0.1 and at most 0.28, and more particularly this ratio is at least 0.15 and at most 0.25.

A semicrystalline thermoplastic polyester that is particularly suitable for producing biaxially oriented films comprises:
a molar amount of 1,4:3,6-dianhydrohexitol units (A) ranging from 2.5 to 14 mol %;
a molar amount of alicyclic diol units (B) other than the 1,4:3,6-dianhydrohexitol units (A) ranging from 31 to 42.5 mol %;
a molar amount of terephthalic acid units (C) ranging from 45 to 55 mol %.

The amounts of different units in the polyester may be determined by ¹H NMR or by chromatographic analysis of the mixture of monomers resulting from complete hydrolysis or methanolysis of the polyester, preferably by ¹H NMR.

Those skilled in the art can readily find the analysis conditions for determining the amounts of each of the units of the polyester. For example, from an NMR spectrum of a poly(1,4-cyclohexanedimethylene-co-isosorbide terephthalate), the chemical shifts relating to the 1,4-cyclohexanedimethanol are between 0.9 and 2.4 ppm and 4.0 and 4.5 ppm, the chemical shifts relating to the terephthalate ring are between 7.8 and 8.4 ppm and the chemical shifts relating to the isosorbide are between 4.1 and 5.8 ppm. The integration of each signal makes it possible to determine the amount of each unit of the polyester.

The semicrystalline thermoplastic polyesters used according to the invention have a melting point ranging from 210 to 295° C., for example from 240 to 285° C.

Furthermore, the semicrystalline thermoplastic polymers have a glass transition temperature ranging from 85 to 120° C., for example from 90 to 115° C. The glass transition temperature and melting point are measured by conventional methods, in particular using differential scanning calorimetry (DSC) using a heating rate of 10° C./min. The experimental protocol is described in detail in the examples section below.

Advantageously, the semicrystalline thermoplastic polyester has a heat of fusion of greater than 10 J/g, preferably greater than 20 J/g, the measurement of this heat of fusion consisting in subjecting a sample of this polyester to a heat treatment at 170° C. for 16 hours, then in evaluating the heat of fusion by DSC by heating the sample at 10° C./min.

The semicrystalline thermoplastic polyester used according to the invention in particular has a lightness L* greater than 40. Advantageously, the lightness L* is greater than 55, preferably greater than 60, most preferentially greater than 65, for example greater than 70. The parameter L* may be determined using a spectrophotometer, via the CIE Lab model.

Finally, the reduced viscosity in solution of said semicrystalline thermoplastic polyester is greater than 50 ml/g and preferably less than 150 ml/g, this viscosity being able to be measured using an Ubbelohde capillary viscometer at 25° C. in an equi-mass mixture of phenol and ortho-dichlorobenzene after dissolving the polymer at 130° C. with stirring, the concentration of polymer introduced being 5 g/l.

This test for measuring reduced viscosity in solution is, due to the choice of solvents and the concentration of the polymers used, perfectly suited to determining the viscosity of the viscous polymer prepared according to the process described below.

The semicrystalline nature of the thermoplastic polyesters used according to the present invention is characterized when the latter, after a heat treatment of 16 h at 170° C., have X-ray diffraction lines or an endothermic melting peak in differential scanning calorimetry (DSC) analysis.

The semicrystalline thermoplastic polyester as defined above has many advantages for producing biaxially oriented films.

Indeed, by virtue in particular of the molar ratio of 1,4:3,6-dianhydrohexitol units (A)/sum of 1,4:3,6-dianhydrohexitol units (A) and alicyclic diol units (B) other than the 1,4:3,6-dianhydrohexitol units (A) of at least 0.05 and at most 0.30 and of a reduced viscosity in solution of greater than 50 ml/g and preferably less than 150 ml/g, the semicrystalline thermoplastic polyesters make it possible to produce biaxially oriented films which have a better heat resistance and improved mechanical properties compared with for example conventional biaxially oriented films produced from polyethylene isosorbide terephthalate (PEIT).

The difference between a biaxially oriented film and a sheet lies in the thickness as such. However, there is no industrial standard which precisely defines the thickness beyond which a sheet is considered to be a biaxially oriented film. Thus, according to the present invention, a biaxially oriented film is defined as having a thickness of less than 250 μm. Preferably, the biaxially oriented films have a thickness of from 5 μm to 250 μm, particularly from 10 μm to 50 μm and even more particularly from 10 μm to 25 μm, such as for example approximately 15 μm.

The biaxially oriented films according to the invention may be directly produced from the melt state after polymerization of the semicrystalline thermoplastic polyester.

According to one alternative, the semicrystalline thermoplastic polyester may be packaged in a form that is easy to handle, such as pellets or granules, before being used for producing biaxially oriented films. Preferentially, the semicrystalline thermoplastic polyester is packaged in the form of granules, said granules being advantageously dried before conversion into the form of biaxially oriented films. The drying is carried out so as to obtain granules having a residual moisture content of less than 300 ppm, preferentially less than 200 ppm, for instance approximately 180 ppm. The biaxially oriented films produced may be single-layer biaxially oriented films or multilayer biaxially oriented films obtained for example by laminating several layers, at least one of which contains a semicrystalline thermoplastic polyester according to the invention.

The biaxially oriented films produced from the semicrystalline thermoplastic polyester according to the invention can be obtained by the methods known to those skilled in the art, for instance flat-die extrusion or else annular-die extrusion (extrusion blow-molding). Preferentially, the biaxially oriented films are produced by the flat-die extrusion method.

The production of a biaxially oriented film via flat-die extrusion, termed “cast extrusion”, consists in stretching, along two axes, a flat sheet at the extruder outlet. Particularly advantageously, this extrusion is carried out by means of a Stenter process which makes it possible to obtain biaxially oriented films by sequential biaxial orientation. The Stenter process is carried out in three steps.

The first step consists in producing a primary film obtained after extrusion through a flat die, which film is stretched in air over a short distance and then cooled on a thermostatted roller, optionally immersed in water. The film thus obtained has an average thickness of approximately 500 μm. The second step consists in carrying out a first stretch in the machine direction (longitudinal) by passing the film over a series of preheating rollers before it is stretched between two rollers rotating at different speeds. The film obtained after this second step then has a thickness of approximately 100 μm. Finally, the third step consists in carrying out a second stretch in the transverse direction. Thus, the uniaxially stretched film obtained in the preceding step is gripped by clasps circulating on rails which move away from one another, the assembly being placed in a hot-air oven. The biaxially oriented film obtained can thus have a thickness of approximately 20 μm.

The production of the biaxially oriented films can also be carried out by extrusion blow-molding and thus consists in extruding the material through an annular die and in simultaneously stretching it in both directions by the combined action of stretching and blow molding. The tubular sheaths thus obtained have a thickness between 10 and 300 μm and a perimeter which ranges from a few centimetres to more than 10 meters. The axis of extrusion may be vertical or horizontal, with balloon heights that can reach more than 20 meters.

According to this method, a thin sheath is extruded, clamped and inflated with air which fills the sheath via the axis of the die head. A first radial stretch is thus carried out by blow-molding. The sheath is subsequently cooled, then stretched longitudinally by stretching rollers.

According to one particular embodiment, the semicrystalline thermoplastic polyester previously defined is used in combination with one or more additional polymers for the production of biaxially oriented films.

The additional polymer may be chosen from polyamides, polyesters other than the polyester according to the invention, polystyrene, styrene copolymers, styrene-acrylonitrile copolymers, styrene-acrylonitrile-butadiene copolymers, poly(methyl methacrylate)s, acrylic copolymers, poly(ether-imide)s, poly(phenylene oxide)s such as poly(2,6-dimethylphenylene oxide), poly(phenylene sulfate)s, poly(ester-carbonate)s, polycarbonates, polysulfones, polysulfone ethers, polyether ketones, and blends of these polymers.

The additional polymer may also be a polymer which makes it possible to improve the impact properties of the polymer, especially functional polyolefins such as functionalized ethylene or propylene polymers and copolymers, core-shell copolymers or block copolymers.

One or more additives may also be added during the production of the biaxially oriented film from the semicrystalline thermoplastic polyester in order to give it particular properties.

Thus, by way of examples of additives, mention may be made of nanometric or non-nanometric, functionalized or non-functionalized fillers or fibers of organic or mineral nature. They may be silicas, zeolites, glass fibers or beads, clays, mica, titanates, silicates, graphite, calcium carbonate, carbon nanotubes, wood fibers, carbon fibers, polymer fibers, proteins, cellulose-based fibers, lignocellulosic fibers and non-destructured granular starch. These fillers or fibers can make it possible to improve the hardness, the rigidity or the water- or gas-permeability.

The additive may also be chosen from opacifiers, dyes and pigments. They may be chosen from cobalt acetate and the following compounds: HS-325 Sandoplast® Red BB (which is a compound bearing an azo function, also known under the name Solvent Red 195), HS-510 Sandoplast® Blue 2B which is an anthraquinone, Polysynthren® Blue R, and Clariant® RSB Violet.

The additive may also be a UV-resistance agent such as, for example, molecules of benzophenone or benzotriazole type, such as the Tinuvin™ range from BASF: tinuvin 326, tinuvin P or tinuvin 234, for example, or hindered amines such as the Chimassorb™ range from BASF: Chimassorb 2020, Chimasorb 81 or Chimassorb 944, for example.

The additive may also be a fire-proofing agent or flame retardant, such as, for example, halogenated derivatives or non-halogenated flame retardants (for example phosphorus-based derivatives such as Exolit® OP) or such as the range of melamine cyanurates (for example melapur™: melapur 200), or else aluminum or magnesium hydroxides.

Finally, the additive may also be an antistatic agent or else an anti-block agent, such as derivatives of hydrophobic molecules, for example Incroslip™ or Incromol™ from Croda.

The biaxially oriented film comprising the semicrystalline thermoplastic polyester may also undergo additional treatments making it possible to improve its properties. By way of example of additional treatments, mention will in particular be made of corona treatment, metallization treatment or alternatively plasma treatment.

The corona treatment makes it possible, via ionization of the air by means of a high-frequency and high-tension electric arc, to create microporosities on the surface of the biaxially oriented film, enabling in particular inks and adhesives to adhere better. Thus treated, the biaxially oriented films have a most particular application for packaging.

The metallization treatment makes it possible, via vacuum evaporation of aluminum, to condense a layer of a aluminum of a few nanometers to a few tens of nanometers at the surface of the biaxially oriented film which is then cooled to prevent melting of said film. This treatment makes it possible to opacify the biaxially oriented film and thus to limit the penetration of light, which is particularly advantageous for avoiding degrading the properties of any content.

Finally, plasma treatment consists in using the atmospheric plasma deposition technology in order to treat the extreme surface (a few nm) of the biaxially oriented film and enable selective grafting of chemical functions to be carried out. This selective grafting may thus provide the biaxially oriented film with a non-stick or adhesion-promoting effect.

The use according to the present invention of semicrystalline thermoplastic polyester for producing biaxially oriented films is particularly advantageous.

Indeed, the biaxially oriented films thus produced from semicrystalline thermoplastic polyester of which the molar ratio of 1,4:3,6-dianhydrohexitol units (A)/sum of 1,4:3,6-dianhydrohexitol units (A) and alicyclic diol units (B) other than the 1,4:3,6-dianhydrohexitol units (A) is at least 0.05 and at most 0.30, and the reduced viscosity in solution of which is greater than 50 ml/g, have noteworthy properties, both from the point of view of the mechanical properties and of the optical quality and also in terms of gas permeability.

Indeed, the biaxially oriented films obtained exhibit improved heat resistance which results in particular in an increase in the drawing rate of the assemblies for the complexed biaxially oriented films and also in a greater temperature use range than the usual biaxially oriented films obtained with PET.

The biaxially oriented films obtained according to the invention also exhibit improved mechanical properties such as the tensile modulus, the yield strength and the tear strength. These improvements make it possible to offer solutions that are more resistant in particular for the packaging market and a better protection of the products via an improvement in the secondary packaging.

The biaxially oriented films produced according to the invention will thus have a most particular use for food applications by virtue of their barrier properties with respect to aromas and by virtue of the possibility of them being used hot and cold, in particular for freezing.

A second subject of the invention relates to a process for producing a biaxially oriented film, said process comprising the following steps of:
provision of a semicrystalline thermoplastic polyester as defined above,
preparation of said biaxially oriented film from the semicrystalline thermoplastic polyester obtained in the preceding step.

The preparation step can be carried out by the methods known to those skilled in the art which are conventionally implemented for the production of biaxially oriented films.

Thus, by way of example, the preparation step can be carried out by the flat-die extrusion method or else the annular-die extrusion method (extrusion blow-molding). Preferentially, the preparation step is carried out by the flat-die extrusion method, termed cast extrusion, and in particular by a Stenter process.

A third subject of the invention relates to a biaxially oriented film comprising the semicrystalline thermoplastic polyester described above. The biaxially oriented film according to the invention may also comprise an additional polymer and/or one or more additives as defined above.

The semicrystalline thermoplastic polyester that is particularly suitable for producing biaxially oriented films may be prepared by a synthesis process comprising:
a step of introducing, into a reactor, monomers comprising at least one 1,4:3,6-dianhydrohexitol (A), at least one alicyclic diol (B) other than the 1,4:3,6-dianhydrohexitols (A) and at least one terephthalic acid (C), the molar ratio ((A)+(B))/(C) ranging from 1.05 to 1.5, said monomers not containing any aliphatic non-cyclic diols or comprising, relative to all of the monomers introduced, a molar amount of aliphatic non-cyclic diol units of less than 5%;
a step of introducing, into the reactor, a catalytic system;
a step of polymerizing said monomers to form the polyester, said step consisting of:
   a first stage of oligomerization, during which the reaction medium is stirred under an inert atmosphere at a temperature ranging from 265 to 280° C., advantageously from 270 to 280° C., for example 275° C.;
   a second stage of condensation of the oligomers, during which the oligomers formed are stirred under vacuum, at a temperature ranging from 278 to 300° C. so as to form the polyester, advantageously from 280 to 290° C., for example 285° C.;
a step of recovering the semicrystalline thermoplastic polyester.

This first stage of the process is carried out in an inert atmosphere, that is to say under an atmosphere of at least one inert gas. This inert gas may especially be dinitrogen. This first stage may be carried out under a gas stream and it may also be carried out under pressure, for example at a pressure of between 1.05 and 8 bar.

Preferably, the pressure ranges from 3 to 8 bar, most preferentially from 5 to 7.5 bar, for example 6.6 bar. Under these preferred pressure conditions, the reaction of all the monomers with one another is promoted by limiting the loss of monomers during this stage.

Prior to the first stage of oligomerization, a step of deoxygenation of the monomers is preferentially carried out. It can be carried out for example once the monomers have been introduced into the reactor, by creating a vacuum then by introducing an inert gas such as nitrogen thereto. This vacuum-inert gas introduction cycle can be repeated several times, for example from 3 to 5 times. Preferably, this vacuum-nitrogen cycle is carried out at a temperature of between 60 and 80° C. so that the reagents, and especially the diols, are totally molten. This deoxygenation step has the advantage of improving the coloration properties of the polyester obtained at the end of the process.

The second stage of condensation of the oligomers is carried out under vacuum. The pressure may decrease continuously during this second stage by using pressure decrease ramps, in steps, or else using a combination of pressure decrease ramps and steps. Preferably, at the end of this second stage, the pressure is less than 10 mbar, most preferentially less than 1 mbar.

The first stage of the polymerization step preferably has a duration ranging from 20 minutes to 5 hours. Advantageously, the second stage has a duration ranging from 30 minutes to 6 hours, the beginning of this stage consisting of the moment at which the reactor is placed under vacuum, that is to say at a pressure of less than 1 bar.

The process also comprises a step of introducing a catalytic system into the reactor. This step may take place beforehand or during the polymerization step described above.

Catalytic system is intended to mean a catalyst or a mixture of catalysts, optionally dispersed or fixed on an inert support.

The catalyst is used in amounts suitable for obtaining a high-viscosity polymer in accordance with the use according to the invention for producing biaxially oriented films.

An esterification catalyst is advantageously used during the oligomerization stage. This esterification catalyst can be chosen from derivatives of tin, titanium, zirconium, hafnium, zinc, manganese, calcium and strontium, organic catalysts such as para-toluenesulfonic acid (PTSA) or methanesulfonic acid (MSA), or a mixture of these catalysts. By way of example of such compounds, mention may be made of those given in application US 2011282020A1 in paragraphs [0026] to [0029], and on page 5 of application WO 2013/062408 A1.

Preferably, a zinc derivative or a manganese, tin or germanium derivative is used during the first stage of transesterification.

By way of example of amounts by weight, use may be made of from 10 to 500 ppm of metal contained in the catalytic system during the oligomerization stage, relative to the amount of monomers introduced.

At the end of transesterification, the catalyst from the first step can be optionally blocked by adding phosphorous acid or phosphoric acid, or else, as in the case of tin(IV), reduced with phosphites such as triphenyl phosphite or tris(nonylphenyl) phosphites or those cited in paragraph [0034] of application US 2011282020A1.

The second stage of condensation of the oligomers may optionally be carried out with the addition of a catalyst. This catalyst is advantageously chosen from tin derivatives, preferentially derivatives of tin, titanium, zirconium, germanium, antimony, bismuth, hafnium, magnesium, cerium, zinc, cobalt, iron, manganese, calcium, strontium, sodium, potassium, aluminum or lithium, or of a mixture of these catalysts. Examples of such compounds may for example be those given in patent EP 1 882 712 B1 in paragraphs [0090] to [0094].

Preferably, the catalyst is a tin, titanium, germanium, aluminum or antimony derivative.

By way of example of amounts by weight, use may be made of from 10 to 500 ppm of metal contained in the catalytic system during the stage of condensation of the oligomers, relative to the amount of monomers introduced.

Most preferentially, a catalytic system is used during the first stage and the second stage of polymerization. Said system advantageously consists of a catalyst based on tin or of a mixture of catalysts based on tin, titanium, germanium and aluminum.

By way of example, use may be made of an amount by weight of 10 to 500 ppm of metal contained in the catalytic system, relative to the amount of monomers introduced.

According to the preparation process, an antioxidant is advantageously used during the step of polymerization of the monomers. These antioxidants make it possible to reduce the coloration of the polyester obtained. The antioxidants may be primary and/or secondary antioxidants. The primary antioxidant may be a sterically hindered phenol, such as the compounds Hostanox® 0 3, Hostanox® 0 10, Hostanox® 0 16, Ultranox® 210, Ultranox® 276, Dovernox® 10, Dovernox® 76, Dovernox® 3114, Irganox® 1010 or Irganox® 1076 or a phosphonate such as Irgamod® 195. The secondary antioxidant may be trivalent phosphorus compounds such as Ultranox® 626, Doverphos® S-9228, Hostanox® P-EPQ or Irgafos 168.

It is also possible to introduce as polymerization additive into the reactor at least one compound that is capable of limiting unwanted etherification reactions, such as sodium acetate, tetramethylammonium hydroxide or tetraethylammonium hydroxide.

Finally, the process comprises a step of recovering the polyester at the end of the polymerization step. The semicrystalline thermoplastic polyester thus recovered can then be formed as described above.

According to one variant of the synthesis process, a step of increasing the molar mass is carried out after the step of recovering the semicrystalline thermoplastic polyester.

The step of increasing the molar mass is carried out by post-polymerization and may consist of a step of solid-state polycondensation (SSP) of the semicrystalline thermoplastic polyester or of a step of reactive extrusion of the semicrystalline thermoplastic polyester in the presence of at least one chain extender.

Thus, according to a first variant of the production process, the post-polymerization step is carried out by SSP.

SSP is generally carried out at a temperature between the glass transition temperature and the melting point of the polymer. Thus, in order to carry out the SSP, it is necessary for the polymer to be semicrystalline. Preferably, the latter has a heat of fusion of greater than 10 J/g, preferably greater than 20 J/g, the measurement of this heat of fusion consisting in subjecting a sample of this polymer of lower reduced viscosity in solution to a heat treatment at 170° C. for 16 hours, then in evaluating the heat of fusion by DSC by heating the sample at 10 K/min.

Advantageously, the SSP step is carried out at a temperature ranging from 190 to 280° C., preferably ranging from 200 to 250° C., this step imperatively having to be carried out at a temperature below the melting point of the semicrystalline thermoplastic polyester.

The SSP step may be carried out in an inert atmosphere, for example under nitrogen or under argon or under vacuum.

According to a second variant of the production process, the post-polymerization step is carried out by reactive extrusion of the semicrystalline thermoplastic polyester in the presence of at least one chain extender.

The chain extender is a compound comprising two functions capable of reacting, in reactive extrusion, with alcohol, carboxylic acid and/or carboxylic acid ester functions of the semicrystalline thermoplastic polyester. The chain extender may, for example, be chosen from compounds comprising two isocyanate, isocyanurate, lactam, lactone, carbonate, epoxy, oxazoline and imide functions, it being possible for said functions to be identical or different. The chain extension of the thermoplastic polyester may be carried out in all of the reactors capable of mixing a very viscous medium with stirring that is sufficiently dispersive to ensure a good interface between the molten material and the gaseous headspace of the reactor. A reactor that is particularly suitable for this treatment step is extrusion.

The reactive extrusion may be carried out in an extruder of any type, especially a single-screw extruder, a co-rotating twin-screw extruder or a counter-rotating twin-screw extruder. However, it is preferred to carry out this reactive extrusion using a co-rotating extruder.

The reactive extrusion step may be carried out by:
introducing the polymer into the extruder so as to melt said polymer;
then introducing the chain extender into the molten polymer;
then reacting the polymer with the chain extender in the extruder;
then recovering the semicrystalline thermoplastic polyester obtained in the extrusion step.

During the extrusion, the temperature inside the extruder is adjusted so as to be above the melting point of the polymer. The temperature inside the extruder may range from 150 to 320° C.

The semicrystalline thermoplastic polyester obtained after the step of increasing the molar mass is recovered and then formed as previously described.

The invention will be understood more clearly by means of the examples and figures is below, which are intended to be purely illustrative and do not in any way limit the scope of the protection.

### EXAMPLES

The properties of the polymers were studied via the following techniques:

Reduced Viscosity in Solution

The reduced viscosity in solution is evaluated using an Ubbelohde capillary viscometer at 25° C. in an equi-mass mixture of phenol and ortho-dichlorobenzene after dissolving the polymer at 130° C. with stirring, the concentration of the polymer introduced being 5 g/l.

DSC

The thermal properties of the polyesters were measured by differential scanning calorimetry (DSC): the sample is first heated under a nitrogen atmosphere in an open crucible from 10 to 320° C. (10° C.min⁻¹), cooled to 10° C. (10° C.min⁻¹), then heated again to 320° C. under the same conditions as the first step. The glass transition temperatures were taken at the mid-point of the second heating. Any melting points are determined on the endothermic peak (onset) at the first heating.

Similarly, the enthalpy of fusion (area under the curve) is determined at the first heating.

For the illustrative examples presented below, the following reagents were used:

1,4-Cyclohexanedimethanol (99% purity, mixture of cis and trans isomers)

Isosorbide (purity >99.5%) Polysorb® P from Roquette Frères

Terephthalic acid (99+% purity) from Acros

Irganox® 1010 from BASF AG

Dibutyltin oxide (98% purity) from Sigma Aldrich

### Example 1: Preparation of a Semicrystalline Thermoplastic Polyester and Use for Producing a Biaxially Oriented Film

A: Polymerization

Two thermoplastic polyesters P1 and P2 were prepared.

The first semicrystalline thermoplastic polyester P1 was prepared according to the procedure below, for use according to the invention with in particular a molar ratio of 1,4:3,6-dianhydrohexitol units (A)/sum of 1,4:3,6-dianhydrohexitol units (A) and alicyclic diol units (B) other than the 1,4:3,6-dianhydrohexitol units (A) of at least 0.05 and at most 0.30.

Thus, 1432 g (9.9 mol) of 1,4-cyclohexanedimethanol, 484 g (3.3 mol) of isosorbide, 2000 g (12.0 mol) of terephthalic acid, 1.65 g of Irganox 1010 (antioxidant) and 1.39 g of dibutyltin oxide (catalyst) are added to a 7.5 l reactor. To extract the residual oxygen from the isosorbide crystals, 4 vacuum-nitrogen cycles are carried out once the temperature of the reaction medium is between 60 and 80° C.

The reaction mixture is then heated to 275° C. (4° C./min) under 6.6 bar of pressure and with constant stirring (150 rpm) until a degree of esterification of 87% is obtained (estimated from the mass of distillate collected). The pressure is then reduced to 0.7 mbar over the course of 90 minutes according to a logarithmic gradient and the temperature is brought to 285° C.

These vacuum and temperature conditions were maintained until an increase in torque of 12.1 Nm relative to the initial torque is obtained.

Finally, a polymer rod is cast via the bottom valve of the reactor, cooled in a heat-regulated water bath at 15° C. and chopped up in the form of granules of about 15 mg.

The resin thus obtained has a reduced viscosity in solution of 80.1 ml/g.

The ¹H NMR analysis of the polyester shows that the final polyester contains 17.0 mol % of isosorbide relative to the diols. With regard to the thermal properties, the polymer has a glass transition temperature of 96° C., a melting point of 253° C. with an enthalpy of fusion of 23.2 J/g.

The second thermoplastic polyester P2 was prepared according to the same procedure as the semicrystalline thermoplastic polyester P1.

This second polyester P2 is a polyester which serves as a comparison and thus has an [A]/([A]+[B]) molar ratio of 0.44. The compound amounts used are given in detail in table 1 below:

TABLE 1

| | | P2 | |
|---|---|---|---|
| COMPOUNDS | 1,4-cyclo- | 859 | g |
| | hexanedimethanol | (6 | mol) |
| | Isosorbide | 871 | g |
| | | (6 | mol) |
| | Terephthalic | 1800 | g |
| | acid | (10.8 | mol) |
| | Irganox 1010 | 1.5 | g |
| | (antioxidant) | | |
| | Dibutyltin oxide | 1.23 | g |
| | (catalyst). | | |

The resin thus obtained with the polyester P2 has a reduced viscosity in solution of 54.9 ml/g.

With regard to the thermal properties, the polyesterr P2 as a glass transition temperature of 125° C., and does not exhibit an endothermic fusion peak in differential scanning calorimetry analysis, even after heat treatment for 16 h at 170° C., thereby indicating its amorphous nature.

B: Forming

The granules of the polyesters P1 and P2 obtained in the polymerization step A are vacuum-dried at 140° C. for P1 and 110° C. for P2 in order to achieve residual moisture contents of less than 300 ppm; in this example, the water content of the granules is 180 ppm.

The granules, kept in a dry atmosphere, are then introduced into the hopper of the extruder.

The extruder used is a Collin extruder fitted with a flat die, the assembly being completed by a calendering machine. The extrusion parameters are collated in table 2 below:

TABLE 2

| Parameters | Units | Values |
|---|---|---|
| Temperature | ° C. | 250/265/275/275/280 (P1) |
| (feed -> die) | | 220/235/245/245/250 (P2) |
| Screw rotation speed | rpm | 80 |
| Temperature | ° C. | 40 |
| of the rollers | | |

The sheets thus extruded from the polyesters P1 and P2 have a thickness of 4 mm.

The sheets are then cut up into squares 11.2×11.2 cm in size and then, using a Brückner Karo IV stretching machine, the cut pieces of the sheets are stretched in two directions, this being carried out at a temperature of from 130° C. to 140° C. with a stretch ratio of 2.8×2.8 and for a time of 2 seconds in both directions. A biaxially oriented film which has a thickness of 14 μm is thus obtained.

The biaxially oriented films thus obtained from the polyesters P1 and P2 have very different properties.

Indeed, the polyester P1 makes it possible to obtain a biaxially oriented film of which the crystal structure was verified by X-ray diffraction/scattering characteristic of stress-induced crystallization during a biaxial stretching phase. The biaxially oriented film obtained has good mechanical properties.

Conversely, when the polyester P2 is extruded, it does not have the possibility of structuring itself in such a way as to reveal a crystal structure. This absence of crystal structure makes it brittle and requires a larger thickness to make it possible for it to be used, thus leading to a more restricted application range. Indeed, this film cannot undergo biaxial orientation treatment on the Karo IV machine without being destroyed.

### Example 2: Preparation of Biaxially Oriented Films

A: Preparation

Two other semicrystalline polyesters P3 and P4 according to the invention were prepared according to the same procedure as example 1. The amounts of the various compounds were adjusted so as to obtain the polyesters P3 and P4 having respectively 15 mol % and 25 mol % of isosorbide.

The amounts were determined by ¹H NMR and are expressed as percentages relative to the total amount of diols in the polyester.

The reduced viscosity in solution of the polyesters P3 and P4 is respectively 75 ml/g and 63 ml/g.

B: Forming Into Sheets

The granules of the polyesters P3 and P4 obtained in step A are then dried for 5 h at 150° C. and have respectively a water content of 0.074% by weight and 0.085% by weight.

The granules, kept in a dry atmosphere, are then introduced into the hopper of the extruder. The extruder used is a Collin extruder fitted with a flat die, the assembly being completed by a calendering machine. The extrusion parameters are collated in table 3 below:

TABLE 3

| Parameters | Units | Values |
|---|---|---|
| Temperature (feed -> die) | ° C. | 210/260/275/295/275 (P3) |
| | | 210/240/255/275/255 (P4) |
| | | 210/255/270/290/260 (P4) |
| | | 210/265/280/300/270 (P4) |
| Screw rotation speed | rpm | 50 |
| Temperature of the rollers | ° C. | 55 |

The sheets thus extruded from the polyesters P3 and P4 have a thickness of 350 μm.

C: Biaxial Stretching

The sheets previously obtained were cut into squares 12×12 cm in size and then stretched by means of a Brückner Karo IV stretching machine. The stretching parameters for each polyester are reproduced below:

TABLE 4

| Parameters | P3 sheets | | P4 sheets | |
|---|---|---|---|---|
| Preheating | 2 | min | 2 | min |
| Machine setpoint | 125° | C. | 135° | C. |

| | | |
|---|---|---|
| temperature | (measured 134° C.) | (measured 138° C.) |
| Stretch ratio | λ = 2*2 | λ = 3*3 |
| | λ = 3*3 | λ = 3.5*3.5 |
| | λ = 3.2*3.2 | |

The stretching speeds were adjusted so as to obtain 100% stretching for the sheets obtained with the polyester P3 and 50% stretching for the sheets obtained with the polyester P4. The stretch time is 2 seconds.

Several biaxially oriented films were thus produced and have thicknesses ranging from 20 μm to 110 μm depending on the stretching speeds. All of the biaxially oriented films are transparent and have a shiny appearance and the stretching is uniform.

As shown in the examples, the semicrystalline thermoplastic polyester according to the invention is an excellent alternative for the production of biaxially oriented films having good mechanical properties.

1-25. (canceled)

26. A biaxially oriented film comprising a semicrystalline thermoplastic polyester comprising:
at least one 1,4:3,6-dianhydrohexitol unit (A);
at least one alicyclic diol unit (B) other than the 1,4:3,6-dianhydrohexitol units (A); and
at least one terephthalic acid unit (C);
wherein the (A)/[(A)+(B)] molar ratio is at least 0.05 and at most 0.30;
said polyester not containing any aliphatic non-cyclic diol units or comprising a molar amount of aliphatic non-cyclic diol units, relative to all the monomer units of the polyester, of less than 5%, and the reduced viscosity in solution (25° C.; phenol (50%m): ortho-dichlorobenzene (50%m); 5 g/l of polyester) of said polyester being greater than 50 ml/g.

27. The biaxially oriented film according to claim 26, wherein the alicyclic diol (B) is a diol chosen from 1,4-cyclohexanedimethanol, 1,2-cyclohexanedimethanol, 1,3-cyclohexanedimethanol or a mixture of these diols, very preferentially 1,4-cyclohexanedimethanol.

28. The biaxially oriented film according to claim 26, wherein the 1,4:3,6-dianhydrohexitol (A) is isosorbide.

29. The biaxially oriented film according to claim 26, wherein the polyester does not contain any aliphatic non-cyclic diol units, or comprises a molar amount of aliphatic non-cyclic diol units, relative to all the monomer units of the polyester, of less than 1%.

30. The biaxially oriented film according to claim 26, wherein the (3,6-dianhydrohexitol unit (A)+alicyclic diol unit (B) other than the 1,4:3,6-dianhydrohexitol units (A))/(terephthalic acid unit (C)) molar ratio is from 1.05 to 1.5.

31. The biaxially oriented film according to claim 26, wherein the biaxially oriented film has a thickness of from 10 μm to 250 μm.

32. The biaxially oriented film according to claim 26, wherein it also comprises one or more additional polymers and/or one or more additives.

33. The biaxially oriented film according to claim 26, wherein the biaxially oriented film is treated by a corona treatment, a metallization treatment or a plasma treatment.

34. A method for the production of a biaxially oriented film, comprising the following steps of:
provision of a semicrystalline thermoplastic polyester comprising at least one 1,4:3,6-dianhydrohexitol unit (A), at least one alicyclic diol unit (B) other than the 1,4:3,6-dianhydrohexitol units (A), at least one terephthalic acid unit (C), wherein the (A)/[(A)+(B)] molar ratio is at least 0.05 and at most 0.30, said polyester not containing any aliphatic non-cyclic diol units or comprising a molar amount of aliphatic non-cyclic diol units, relative to all the monomer units of the polyester, of less than 5%, and the reduced viscosity in solution (25° C.; phenol (50%m): ortho-dichlorobenzene (50%m); 5 g/l of polyester) of said polyester being greater than 50 ml/g; and
preparation of said biaxially oriented film from the semicrystalline thermoplastic polyester obtained in the preceding step.

35. The method according to claim 34, wherein the preparation step is carried out by the cast extrusion method and in particular by the Stenter process.

36. The method according to claim 34, wherein the alicyclic diol (B) is a diol chosen from 1,4-cyclohexanedimethanol, 1,2-cyclohexanedimethanol, 1,3-cyclohexanedimethanol or a mixture of these diols.

37. The method according to claim 34, wherein the 1,4:3,6-dianhydrohexitol (A) is isosorbide.

38. The method according to claim 34, wherein the polyester does not contain any aliphatic non-cyclic diol units, or comprises a molar amount of aliphatic non-cyclic diol units, relative to all the monomer units of the polyester, of less than 1%.

39. The method according to claim 34, wherein the (3,6-dianhydrohexitol unit (A)+alicyclic diol unit (B) other than the 1,4:3,6-dianhydrohexitol units (A))/(terephthalic acid unit (C)) molar ratio is from 1.05 to 1.5.

40. The method according to claim 34, wherein the biaxially oriented film has a thickness of from 10 μm to 250 μm.

41. The method according to claim 34, wherein the biaxially oriented film comprises one or more additional polymers and/or one or more additives.

42. The method according to claim 34, wherein the biaxially oriented film is treated by a corona treatment, a metallization treatment or a plasma treatment.
